(19) United States
(12) Patent Application Publication
(10) Pub. No.: US 2016/0305331 A1
(43) Pub. Date: Oct. 20, 2016

(54) TURBOMACHINE ACCESSORY GEARBOX EQUIPPED WITH A CENTRIFUGAL PUMP

(71) Applicant: HISPANO-SUIZA, Colombes (FR)

(72) Inventors: Stephane PRUNERA-USACH, Rueil Malmaison (FR); Boris MORELLI, Paris (FR); Samuel THIBERGE, Bretteville-sur-Odon (FR)

(73) Assignee: Hispano-Suiza, Colombes (FR)

(21) Appl. No.: 14/898,906

(22) PCT Filed: Jun. 17, 2014
(86) PCT No.: PCT/FR2014/051502

§ 371 Date: Dec. 16, 2015

(30) Foreign Application Priority Data
Jun. 21, 2013 (FR) 1355940

(51) Int. Cl. F02C 7/32; F04D 25/02; F04D 29/60; F04D 29/42; F02C 7/36; F04D 13/02

(52) U.S. Cl. CPC F02C 7/32; F02C 7/36; F04D 13/02; F04D 29/605; F04D 29/4206; F04D 29/601; F04D 29/426; F04D 25/02; F05D 2260/4031; F05D 2220/30

(57) ABSTRACT

An accessory gearbox for a turbomachine, the gearbox being equipped with a pump and including intermeshing pinions, one of which is formed as a single piece with a coaxial shank for driving a rotary part of the pump, wherein said rotary part is directly mounted on the shank.

### TECHNICAL FIELD

The present invention relates to an accessory gearbox for a turbine engine, this accessory gearbox, also referred to as an AGB, being provided with an apparatus and in particular a pump such as a centrifugal pump.

### PRIOR ART

The continuous search for performance in an aeronautical engine leads to integrating an accessory gearbox in a more and more constrained environment. The overall size of an accessory gearbox contributes to the overall performance of the engine. It therefore becomes necessary to reduce the size of the accessory gearbox and the apparatuses thereof.

An accessory gearbox for a turbine engine is intended to transmit mechanical power originating from the turbine engine to apparatuses such as a pump, an air/oil separator, an electricity generator, etc. The accessory gearbox comprises intermeshing pinions, at least some of which are rigidly connected to coaxial shanks intended to rotate the moving parts or rotors of the apparatuses.

In the prior art, the aforementioned shank of each pinion in the gearbox passes through an orifice in the casing of the accessory gearbox and is connected outside the gearbox to a shaft of the rotating part of the apparatus.

When the apparatus is a centrifugal pump, for example a fuel pump, this pump comprises a wheel that is constrained to rotate with a shaft that is intended to be rotated by the shank of the pinion. The shaft is rotationally guided by bearings mounted in the centrifugal pump. This centrifugal pump is of the volute type, this volute forming part of the fixed part or stator of the pump and allowing the pressure necessary for the correct functioning of the pump to be generated. The fixed part-moving part assembly of the pump is connected to the accessory gearbox by means of the shank of the pinion and is then fixed to the casing of this gearbox.

However, this technology is not satisfactory since the gearbox and the apparatus are too bulky, which makes it difficult to integrate them in the turbine engine.

The invention provides a simple, effective and economical solution to this problem.

### DISCLOSURE OF THE INVENTION

The invention proposes an accessory gearbox for a turbine engine, this gearbox being provided with a pump and comprising intermeshing pinions, one of which is formed integrally with a coaxial shank for driving a rotating part of the pump, characterised in that this rotating part is directly mounted on the aforementioned shank.

According to the invention, a part of the pump is integrated in the accessory gearbox and in particular in the space defined by the casing of the accessory gearbox. This is made possible by the fact that the rotating part of the pump is directly mounted on the shank of a pinion of the accessory gearbox. In other words, as opposed to the prior art, in which the rotating part was carried by a shaft intended to be driven by the shank of a pinion of the gearbox, the rotating part is in this case directly carried by the shank of the pinion. This makes it possible to eliminate both the shaft of the pump from the prior art and its guide bearings, and results in a saving in mass and a significant reduction in the axial size of the gearbox and of the pump (the axis in question here being the rotation axis of the pinion shank and of the rotating part of the pump). Moreover, the rotating part of the pump may be rotationally guided by the guide bearings of the shank of the pinion, which improves the reliability of the assembly.

In a preferred embodiment of the invention, the pump is a centrifugal pump and its rotating part is a wheel that is directly mounted on one end of the aforementioned shank.

The wheel may be mounted between a first and a second casing of the centrifugal pump, which are fixed to a casing of the gearbox.

The shank is preferably rotationally guided by a bearing carried by the first casing. The first casing may be in the form of a disc. It may comprise a central orifice for the shank to pass through. The first casing may comprise at its internal periphery a cylindrical rim for mounting the bearing for guiding the shank.

The second casing may comprise at its external periphery a flange for fixing for example to a fixing flange of the first casing or of the casing of the gearbox.

The centrifugal pump may comprise a volute defined by the second casing or the casing of the gearbox.

The first casing may define, together with the wheel, an annular space for housing sealing means, for example dynamic ones.

The present invention also concerns a turbine engine, such as a turbojet engine, a turboprop engine or a turboshaft engine for an aeroplane or helicopter, characterised in that it comprises a gearbox as described above.

### DESCRIPTION OF THE FIGURES

The invention will be understood more clearly and other details, features and advantages of the invention will emerge upon reading the following description given by way of non-limiting example and with reference to the accompanying drawings, in which:

FIG. 1 is a highly schematic view of a turbine engine accessory gearbox on which two apparatuses are mounted;

FIG. 2 is a highly schematic partial view in axial section of an accessory gearbox equipped with a centrifugal pump, and represents the art prior to the invention;

FIG. 3 is a highly schematic partial view in axial section of an accessory gearbox equipped with a centrifugal pump, and represents the invention, and

FIGS. 4 and 5 are schematic partial views in axial section and in perspective of an accessory gearbox and of a centrifugal pump according to the invention.

### DETAILED DESCRIPTION

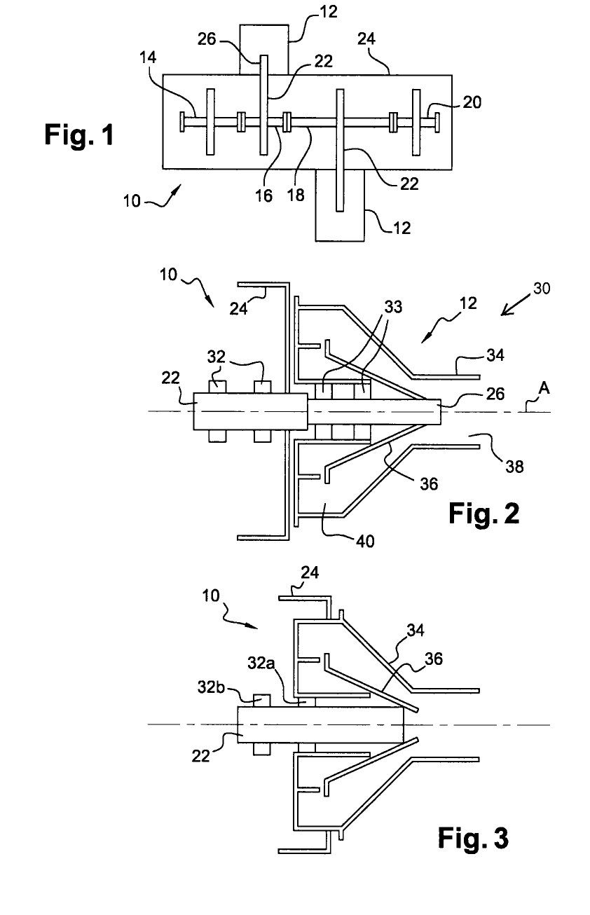

Reference is made first of all to FIG. 1, which depicts highly schematically an accessory gearbox 10 for a turbine engine, such as a turbojet engine, a turboprop engine or a turboshaft engine for an aeroplane or helicopter, this gearbox 10 being equipped with accessories or apparatuses 12, of which there are two in the example depicted.

The accessory gearbox 10 is intended to transmit mechanical power originating from the turbine engine by means of a radial shaft emerging therefrom, and to transmit it to the apparatuses, including pumps, air/oil separators, electricity generators, etc. The transmission takes place through a kinematic chain consisting of successive pinions 14, 16, 18, 20, of which there are four in the example depicted.

The pinions 16 and 20 each comprise a coaxial shank 22, which is formed integrally with the corresponding pinion, and which passes through an orifice in the casing 24 of the accessory gearbox. The end part of the shank 22 of the pinion, situated outside the gearbox 10, is engaged with a shaft 26 of the rotating part of the corresponding apparatus 12 in order to rotate this rotating part.

FIG. 2 is a highly schematic view to a larger scale of the region where a pinion shank 22 is connected to a rotor shaft 26 of an apparatus 12, which in this case is a centrifugal pump 30 having a volute.

The shank 22 of the pinion is centred and rotationally guided by bearings 32 that are mounted in the casing 24 of the accessory gearbox 10. The shaft 26 of the apparatus 12 is connected by one end to the part of the shank 22 situated outside the casing 24 and is centred and rotationally guided by bearings 33 mounted in a fixed part, such as a casing 34, of the pump (apparatus 12).

The centrifugal pump comprises a wheel 36 that is carried by the shaft 26 and is constrained to rotate with the shaft. The casing 34 of the pump defines a fluid inlet 38 upstream of the wheel 26, a volute 40 and a fluid outlet downstream of the wheel, i.e. at the external periphery thereof.

The technology depicted in FIG. 2, which represents the prior art, has the drawback of being axially bulky (axis A). The invention, depicted schematically in FIG. 3, makes it possible to overcome this problem by integrating a part of the apparatus 12, namely the centrifugal pump in the aforementioned example, in the casing 24 of the accessory gearbox.

This is made possible by the direct mounting of the rotating part of the apparatus on the shank of the pinion. In FIG. 3, the wheel 36 of the pump is in fact fixed to one end of the shank 22. Part of the casing of the pump is housed inside the casing 24 of the accessory gearbox 10 and further serves as a support for a first bearing 32a for guiding the shank 22, another bearing 32b for guiding the shank being carried by the casing 24 of the accessory gearbox 10.

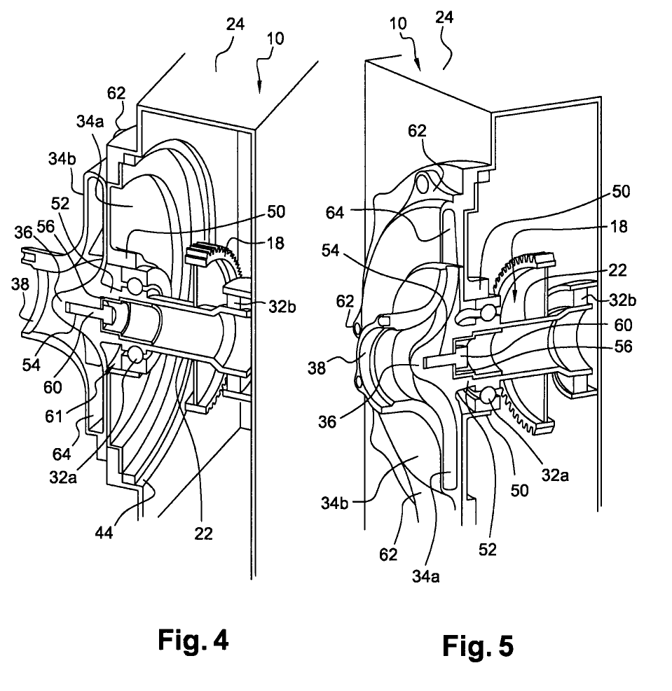

Reference is now made to FIGS. 4 and 5, which depict a more concrete embodiment of the invention, and in which the elements already described above are designated by the same references.

The casing 24 of the accessory gearbox 10 comprises an opening 44 having a circular contour that has the shank 22 of the pinion 18 passing through it axially. As can be seen in the drawings, the pinion 18 and the shank 22 are formed in a single piece, the shank having a roughly tubular cylindrical shape in this case. The shank 22 is rotationally guided by the bearings 32a, 32b, the bearing 32b being carried by the casing 24 and the bearing 32a being carried by a first casing 34a of the pump.

This first casing 34a is in the form of a disc and is intended to be applied and clamped against the casing 24 of the gearbox 10 in order to close off the aforementioned opening 44. This first casing 34a comprises a central bore for the shank 22 to pass through and comprises at its internal periphery a cylindrical rim 50 extending inside the gearbox 10 and inside which the external cage of the bearing 32a is fixed, which is of the ball type in this case. The internal cage of the bearing 32a is fixed to the shank 22.

In a conventional fashion, the wheel 36 of the pump comprises a central hub surrounded by an annular wall and connected to this wall by blades, the hub and the wall defining therebetween a centrifugal stream having an axial inlet and a radial outlet.

The wheel 36 of the pump is formed integrally with a rim 52, as opposed to being mounted on the end of the shank 22. In the example depicted, the rim 52 is connected to the hub of the wheel 36 and extends axially on the opposite side to the inlet of the centrifugal stream.

The rim 52 has an internal diameter slightly greater than the external diameter of this end of the shank. In the mounting position, the rim 52 passes axially through the opening in the first casing 32a and the opening 44 in the casing 24 of the accessory gearbox 10.

The end of the shank 22 of the pinion, which passes through the opening 44 in the gearbox 24, comprises a radially internal annular rim 56, the internal periphery of which defines a passage orifice for a screw 60 for fixing the wheel 36 to the shank. The hub of the wheel 36 comprises a tapped axial hole 54 which, in the mounting position, is aligned with the orifice thereof. The screw 60 is engaged inside the shank and is then screwed in the hole 54 of the wheel 36 through the orifice in the end of the shank 22. This screwing ensures axial holding of the wheel 36 on the shank 22. This assembly between the wheel 36 and the shank 22 must be supplemented by means of a form-locked connection (type P3G or similar), constraining the parts to rotate with respect to each other.

The external periphery of the wheel 36 defines, together with the first casing 34a, an annular space 61 in which dynamic sealing means of the type consisting of a carbon contact gasket or separation gasket for example can be housed. In the case of a fuel pump, a double dynamic sealing having an intermediate drain may be used in order to prevent oil/fuel mixing.

A second casing 34b is attached and fixed to the first casing 34a and defines, together with this first casing, a chamber for housing and rotating the wheel 36. This second casing 34b comprises at its external periphery a flange 62 for fixing by means of the screw and nut type on a corresponding annular flange (not visible) of the casing of the gearbox 10, the external periphery of the first casing 34a being interposed between these flanges and intended to be clamped between these flanges by screw clamping. In a variant, the casing 34b may be fixed directly to the casing 34a.

The second casing 34b defines a substantially cylindrical tubular inlet 38 for supplying fluid to the pump, and an annular peripheral space 64 for the fluid to emerge from the pump, this space comprising a volute (not visible).

1. An accessory gearbox for a turbine engine, this gearbox being provided with a pump and comprising intermeshing pinions. one of which is formed integrally with a coaxial shank for driving a rotating part of the pump, wherein this rotating part is directly mounted on the aforementioned shank.

2. The accessory gearbox according to claim 1, wherein the pump is a centrifugal pump and its rotating part is a wheel that is directly mounted on one end of the aforementioned shank.

3. The accessory gearbox according to claim 2, wherein the wheel is mounted between a first and a second casing of the centrifugal pump, which are fixed to a casing of the accessory gearbox.

4. The accessory gearbox according to claim 3, wherein the shank is rotationally guided by a bearing carried by the first casing.

5. The accessory gearbox according to claim 3, wherein the first casing comprises a central orifice for the shank to pass through.

6. The accessory gearbox according to claim 4, wherein the first casing comprises at its internal periphery a cylindrical rim for mounting the bearing for guiding the shank.

7. The accessory gearbox according to claim 3, wherein the second casing comprises a fixing flange at its external periphery thereof.

8. The accessory gearbox according to claim 3, wherein the centrifugal pump comprises a volute defined by the second casing of the centrifugal pump or the casing of the accessory gearbox.

9. The accessory gearbox according to claim 3, wherein the first casing defines with the wheel an annular space for housing sealing means.

10. A turbine engine, such as a turbojet engine, a turboprop engine or a turboshaft engine for an aeroplane or helicopter, comprising an accessory gearbox according to claim 1.
